(19) United States
(12) Patent Application Publication
(10) Pub. No.: US 2026/0337983 A1
(43) Pub. Date: Oct. 29, 2026

(54) METHOD FOR MANUFACTURING A PANEL

(71) Applicant: UNILIN, BV, Wielsbeke (BE)

(72) Inventors: Marijn SEYNAEVE, Wielsbeke (BE); Benjamin CLEMENT, Wielsbeke (BE)

(21) Appl. No.: 19/107,890

(22) PCT Filed: Sep. 5, 2023
(86) PCT No.: PCT/IB2023/058753

§ 371 Date: Feb. 28, 2025

(30) Foreign Application Priority Data
Sep. 13, 2022 (BE) 2022/5725

(51) Int. Cl. E04F 15/10; B32B 3/06; B32B 7/12; B32B 13/02; B32B 13/08; E04F 15/02

(52) U.S. Cl. CPC E04F 15/107; B32B 3/06; B32B 7/12; B32B 13/02; B32B 13/08; E04F 15/02038; B32B 2307/584; B32B 2471/00; E04F 2201/0153; E04F 2201/023; E04F 2201/042; E04F 2201/043

(57) ABSTRACT

The method includes the steps of: providing a mass which includes a carbonatable powder, bringing this mass into a sheet form and compacting into a sheet form, carbonating this mass that has been brought into a sheet form and compacted, so that a panel is obtained with a thickness of less than 60 mm.

This invention relates to a method for manufacturing a panel, preferably a method for manufacturing a decorative panel.

Carbonatation is known for the production of building materials. WO2020/260568A1 describes a method for manufacturing an object bound by carbonatation.

The object of the invention is to provide methods that allow the manufacture, by means of carbonatation of suitable starting material, of panels—and preferably decorative panels—which have excellent properties and that can be manufactured in a better way.

The specific object of the invention is to provide panels that can be manufactured with a limited amount of energy and that have an extremely low CO₂ footprint, due to the fact that CO₂ is bound in the panel during manufacturing.

The first aspect of the invention relates to a method for manufacturing a panel, preferably a decorative panel. The method comprises the steps of:
providing a mass which comprises a carbonatable powder,
bringing this mass into a sheet form; and compacting into a sheet form;
carbonating this mass that has been brought into a sheet form and compacted, so that a panel is obtained with a thickness of less than 60 mm; preferably with a thickness of less than 30 mm, more preferably with a thickness less than 20 mm, more preferably with a thickness less than 14 mm, more preferably with a thickness less than 10 mm, more preferably with a thickness less than 8 mm, more preferably less than 5 mm; and preferably higher than 3 mm.

CO₂ is absorbed during the carbonatation and is bound in the panel. This can be done with low energy consumption, as no elevated temperatures are required as is the case with the production of ceramic tiles. Due to these factors, the method has a low carbon footprint. The method also allows to obtain waterproof panels, which are also fireproof.

For use in wall panels, the thickness is preferably less than 5 mm, for example 3 mm.

For use in floor panels, the thickness is preferably less than 20 mm. Preferably the thickness is between 8 and 14 mm for floor panels for indoor use. Preferably the thickness is less than 20 mm for floor panels for outdoor use.

Panels with a lower thickness allow to accelerate the carbonatation and to improve its efficiency since CO₂ has to penetrate less deeply in order to carbonate the entire thickness.

A preferred embodiment is characterized in that the mass comprises water, preferably between 12 and 16% by mass of water. This allows that the mass is still in powder form (i.e., not in wet slurry form). The water allows to promote the carbonatation process, since CO₂ can diffuse into water and thus be guided through the compacted sheet form, so that the entire thickness of the sheet form can be effectively and efficiently bound by carbonatation.

The mass which comprises a carbonatable powder in powder form allows processing by scattering in order to bring the mass into a sheet form.

Alternatively, a sufficient amount of water can also be added so that the mass which comprises a carbonatable powder in a slurry form can be provided. This allows other possibilities of processing the mass, for example by extrusion and casting to bring the mass into a sheet form.

A preferred embodiment is characterized in that in the particle size distribution by volume of the carbonatable powder at least 40% of the particles have a particle size of smaller than 1000 μm, more preferably higher than 500 μm, more preferably higher than 200 μm. In the context of this invention, the particle size distribution by volume is measured by laser diffraction.

This embodiment offers the advantage that a better compaction can be obtained. This also leads to carbonated panels that have a lower porosity, which is beneficial for the water resistance and chemical resistance of the panels. In this embodiment, the carbonatable powder also has a higher reactivity. So, this embodiment leads to higher quality panels.

This embodiment also ensures that a texture can be better pressed into the surface of the panel when compacting.

A preferred embodiment is therefore characterized by the fact that water is added when providing the mass. The water allows to promote the carbonatation process, since CO₂ can diffuse into water and thus be guided through the compacted sheet form, so that the entire thickness of the sheet form can be effectively and efficiently bound by means of carbonatation.

A preferred embodiment is characterized in that the mass comprises powdered or granulate-shaped fillers, for example CaCO₃ or sand. This embodiment allows to reduce the cost of the raw materials and to change the properties of the panel.

A preferred embodiment is characterized in that the mass is a mass which can be scattered. This embodiment allows to bring the mass into a sheet form in a simple manner. This also allows to avoid drying, which is the case if the mass in wet slurry form is brought into in the sheet form. Since no drying is required, less energy is required in the manufacture of the panel.

A preferred embodiment is characterized in that the carbonatation is performed in an atmosphere that comprises a higher fraction of CO₂ than the ambient atmosphere. This will ensure an efficiency and effective carbonatation, which will provide a solid and strong panel.

A preferred embodiment is characterized in that carbonatation involves applying one or more of:
a carbonatation using moisture added to CO₂-enriched air;
a carbonatation at elevated temperature;
the use of CO₂ already added before compacting;
a carbonatation in at least two steps; wherein preferably in a first step the carbonatation is performed at a lower pressure than in the second step.

Carbonatation using moisture added to CO₂-enriched air offers the advantage that the moisture ensures that the CO₂ will be absorbed and transported through the compacted sheet form, so that the carbonatation is performed efficiently and effectively.

Carbonatation at elevated temperature offers the advantage of accelerating the carbonatation reaction, so that the manufacture of the panel runs faster.

Using CO₂ already added before compacting offers the advantage that the carbonatation is performed faster and more efficiently. The CO₂ can be more easily distributed throughout the mass if CO₂ is already supplied before compacting.

A preferred embodiment is characterized in that the mass comprises one or more of a fast-setting cement, plaster, a polymer binder-preferably in powder form-, a (synthetic or non-synthetic) adhesive-preferably in powder form-, alkaline water glass or a carbonatable agent, for example potassium carbonate, potassium bicarbonate, magnesium carbonate hydroxide hydrate (xMgCO₃.yMg(OH)₂.zH₂O with x=3.5-4.5, y=0.5-1.5 and z=3.5-5.5).

This kind of embodiments offers the advantage that the dimensional stability of the compacted sheet form is better. This will improve the quality of the formed panel. Mechanical operations—for example, sawing into panels or milling the coupling means at the edges of the panels—are also possible before carbonatation. Due to the fact that the material before carbonatation is softer—but still dimensionally stable—, this sawing and/or milling can be done with less energy, and there is no danger that brittleness of the material would cause problems during these mechanical operations.

A preferred embodiment is characterized in that the mass comprises a fast-setting Portland cement, or consists mainly of it, or wherein the mass comprises calcium sulfoaluminate. This kind of embodiments offers the advantage that the dimensional stability of the compacted sheet form is better. This will improve the quality of the formed panel. A texture can also be inserted by pressure during compaction, this texture being retained until after carbonatation. Mechanical operations—, for example, sawing into panels or milling the coupling means at the edges of the panels—are also possible before carbonatation. Due to the fact that the material before carbonatation is softer—but still dimensionally stable—, it can be sawn and/or milled with less energy, and there is no danger that brittleness of the material would cause problems during these mechanical operations.

When, on the one hand, the mass comprises fast-setting Portland cement or calcium sulfoaluminate; on the other hand, the mass preferably comprises an acid, for example citric acid or phosphoric acid. This will ensure inhibition, so that the Portland cement or the calcium sulfoaluminate is not activated too early, but the mass can be effectively brought into a sheet form, and only afterwards, during or after compacting, the Portland cement or the calcium sulfoaluminate will provide dimensional stability.

A preferred embodiment is characterized in that the mass which comprises a carbonatable powder also comprises wood chips and/or wood fibres. This allows to achieve the desired mechanical properties of the panel. This also allows to obtain a more efficient milling of the coupling means on the side edges of panels obtained with the method of the first aspect of the invention. Also, the presence of the wood chips and/or the wood fibres allows to laminate a decor layer on the surface of the panel using melamine or another resin to form a decorative panel.

A preferred embodiment is characterized in that the mass which comprises a carbonatable powder also comprises reinforcing fibres, preferably wherein the fibres form between 0.75 and 5 % by mass of the mass which comprises a carbonatable powder. This kind of embodiments allows to obtain a panel with higher strength.

Preferably, the reinforcing fibres are selected from one or more of:
wood fibres;
synthetic fibres, such as for example polyethylene fibres, polypropylene fibres, polyester fibres, polyvinyl alcohol fibres, polyamide fibres, acrylic fibres, aramid fibres;
cellulose fibres, such as for example cotton, flax, hemp, bamboo, jute, sisal, elephant grass, flax, coconut fibre or ramie;
animal fibres, such as for example wool or other animal hair;
inorganic fibres, such as for example glass fibres, basalt fibres, metal fibres, carbon fibres.

Preferably, the average length of the reinforcing fibres is between 3 and 40 mm, more preferably between 3 and 20 mm. This ensures that a good strength of the panel will be obtained, while the mass which comprises a carbonatable powder (and the reinforcing fibres) can still be properly processed and brought into a sheet form.

Preferably, the reinforcing fibres have an average aspect ratio between 75 and 1000, more preferably between 75 and 400; wherein the aspect ratio is determined by the length divided by the apparent diameter. This ensures that a good strength of the panel will be obtained, while the mass which comprises a carbonatable powder (and the reinforcing fibres) can still be properly processed and brought into a sheet form.

Preferably, the reinforcing fibres have been treated to improve the compatibility with the to be formed matrix in the panel, wherein the treatment can be for example, a silane treatment, a heat treatment, or a coating. Since a better adhesion between the reinforcing fibres and the matrix is obtained, a panel with better mechanical properties will be provided.

A preferred embodiment is characterized in that during the bringing of the mass into the sheet form, a non-woven fabric, for example a non-woven fabric made up of glass fibres, is introduced, wherein the non-woven fabric is brought into the sheet form parallel with the sheet form. This allows to increase the mechanical properties of the manufactured panel.

A preferred embodiment is characterized in that the mass is brought into a sheet form by means of scattering the mass which comprises a carbonatable powder. This scattering is a very efficient way to bring the mass into a sheet form. The technology can be used as used, for example, in the production of chip boards or wood fibre boards.

The scattering is optionally followed by an equalization step, for example by means of a roll. This will provide a more even sheet form, favourable to limit the variation in thickness, composition, and properties of the manufactured panel.

Preferably, the scattering is performed on a continuously moving organ, more preferably a conveyor belt. This allows to provide a continuous manufacture.

A preferred embodiment is characterized in that the mass which comprises a carbonatable powder is formed into a slurry with water, wherein the method comprises the step wherein this mass in a slurry form is brought into a sheet form, for example by extruding the slurry or pouring it into a mould. This embodiment allows to avoid dust when bringing the mass which comprises a carbonatable powder into a sheet form.

A preferred embodiment is characterized in that the compaction into a sheet form is performed by means of a continuous press processing—whether or not at elevated temperature—; for example, by means of a double belt press. This will provide a continuous production.

A preferred embodiment is characterized in that compacting into a sheet form is performed by means of a takt time press (for example a short cycle press or a multiday-light press).

A preferred embodiment is characterized in that a texture is created on a surface of the sheet form when compacting into a sheet form. In this step, the texture can be easily inserted by pressure. The texture has been found to be retained after carbonatation. So, when implementing this embodiment, a texture can be obtained on the surface of the panel with a very efficient process.

This texture can be, for example, a wood structure or a natural stone structure. A marble structure can be mentioned as an example of a stone structure.

Optionally, the texture is created in register with the colour pattern formed on the surface by scattering two masses which comprise a carbonatable powder that differ in colour, for example by differences in quantity and/or colour of pigments in these two masses. In this way, a very realistic imitation of natural materials (e.g., marble) can be obtained.

For example, the texture can be obtained by means of a structured press plate or by means of a mould.

A preferred embodiment is characterized in that a relief is pressed on the intended bottom side of the panel when compacting into a sheet form. This allows to make lighter panels. This relief is also favourable for the gluing of the panels on a surface.

A preferred embodiment is characterized in that after or during the bringing into a sheet form of the mass which comprises a carbonatable powder—preferably before or after the compacting into a sheet form—water is applied on the mass; this water can be applied in liquid form or in the form of steam. This water offers the advantage that it can serve as a means of transport for CO₂ through the sheet during the carbonatation. This ensures that a more efficient and effective carbonatation process can be provided.

The application of water in the form of steam offers the advantage that it can penetrate more easily into the sheet form, so that the carbonatation process can be more efficiently performed and the properties throughout the manufactured panel will be more uniform.

Optionally, the water which is applied to the mass comprises additives such as for example one or more of a release agent, an inhibitor, or a hydrophobic agent. This improves the process conditions and/or improves the properties of the manufactured panel.

The water can be applied in liquid form by means of spraying.

Optionally, the water applied to the mass may comprise an adhesive or a polymer binder, for example an acrylate, a styrene acrylate, a vinyl acetate, a vinyl acetate chloride, a styrene butadiene copolymer, a vinylidene chloride; optionally, the glue may be a pressure and/or moisture-sensitive glue, for example an isocyanate-based glue. These embodiments offer the advantage of obtaining better dimensional stability for performing the carbonatation. On the other hand, these embodiments can also provide better mechanical properties of the panel after carbonatation.

A preferred embodiment is characterized in that the carbonatable powder is obtained or derived from slag from a metallurgical process (for example blast furnace slag), fly ash or calcined clay.

A preferred embodiment is characterized in that the carbonatable powder is obtained from one or more of stainless-steel slag, steel slag, zinc slag, copper slag, phosphorus slag, fly ash or bottom ash. This means that the powder that together with the CO₂ will provide the binding in the panel during the carbonatation is obtained from a waste product from an industrial process. This represents a significant valorisation of this waste product.

A preferred embodiment is characterized in that the carbonatable powder comprises CaO. According to this embodiment, panels with good mechanical properties can be obtained.

A preferred embodiment is characterized in that the carbonatable powder comprises at least 25% by mass of Ca²⁺, and more preferably comprises at least 30% by mass of Ca²⁺. According to this embodiment, panels with good mechanical properties can be obtained.

A preferred embodiment is characterized in that the mass which comprises a carbonatable powder also comprises a superplasticizer (for example polycarboxylate ether) or is mixed in it. This embodiment offers the advantage that during the bringing into a sheet form and during compacting, the materials slide more easily alongside each other, so that a more efficient and better compacted sheet form is obtained. This advantage is obtained when the mass is brought into a sheet form by means of scattering, but also when this is performed using a wet slurry.

A preferred embodiment is characterized in that the mass which comprises a carbonatable powder also comprises or is mixed with a chelating agent (for example EDTA or phosphonic acid).

Using a chelating agent offers the advantage that the carbonatation reaction proceeds faster. The inventors suspect that this is due to the fact that the chelating agent binds well with Ca²⁺ ions from the carbonatable powder. This promotes the extraction of Ca²⁺ ions from the carbonatable powder. This released Ca²⁺ can then react with CO₂. In addition, the chelating agent can also favourably affect CaCO₃ crystallization.

A preferred embodiment is characterized in that the mass which comprises a carbonatable powder also comprises or is mixed with a hydrophobic agent (for example metal soaps, silanes, siloxanes, acrylates, or latex). This offers the advantage that the obtained panel has a better water resistance.

A preferred embodiment is characterized in that the mass which comprises a carbonatable powder also comprises or is mixed with colour pigments (preferably inorganic pigments) or other fillers (for example shells, granite powder or marble powder) for decorative application. This allows to produce a mass-coloured or decorated panel.

A preferred embodiment is characterized in that the method uses two masses which comprise a carbonatable powder that are brought together into a sheet form; wherein the masses which comprise a carbonatable powder differ in colour, for example because they comprise different pigments and/or different amounts of pigments; wherein the two masses which comprise a carbonatable powder are brought into a sheet form—for example by means of computer-controlled scattering operations—so that a decorative colour pattern is obtained on the surface of the sheet form. This therefore allows to obtain a decorative colour pattern on the surface of the panel. An example is the realization of a black vein against a lighter background as an imitation of marble.

A preferred embodiment is characterized in that during the bringing into a sheet form, different layers are formed of masses which comprise a carbonatable powder, wherein at least two layers differ in the composition of the masses; preferably at least three different layers of masses which comprise a carbonatable powder are formed. This allows to provide layers with different properties, so that the panel as a whole has better properties. For example, a top layer can be coloured decoratively while the other layers are not. It is also possible to create some kind of a sandwich structure with different properties in the core layer in comparison with the two outer layers.

In an embodiment, a top layer made up of the mass which comprises a carbonatable powder is formed and a second layer made up of the mass which comprises a carbonatable powder is formed under the top layer, wherein in the formed panel the top layer is harder and/or more brittle than the second layer.

Optionally, a third layer made up of the mass which comprises a carbonatable powder is formed under the second layer, wherein the third layer is harder and/or more brittle in the formed panel than the second layer. For example, the more flexible second layer makes it easier to mill mechanical coupling means on the edges of the panel, while the top layer and the third layer provide the mechanical properties.

Preferably, the top layer made up of the mass which comprises a carbonatable powder also comprises colour pigments (preferably inorganic pigments) or other fillers (for example shells, granite powder or marble powder) for decorative application ; and preferably the second layer made up of the mass which comprises a carbonatable powder does not comprise them or relatively much less. This allows in an elegant way to obtain a coloured or decorative surface, wherein the use of colour pigment or other decorative fillers remains limited.

Preferably the top layer made up of the mass which comprises a carbonatable powder and/or the bottom layer made up of the mass which comprises a carbonatable powder has/have a higher weight of reinforcing fibres per unit of volume than at least one other layer made up of the mass which comprises a carbonatable powder. This allows the properties—including the mechanical properties—of the panel to be optimized.

A preferred embodiment is characterized in that the mass which comprises a carbonatable powder is brought into a sheet form on a carrier plate, wherein in the method the mass which comprises a carbonatable powder binds to the carrier plate—preferably during the carbonatation—so that the carrier plate becomes part of the manufactured panel. This offers the advantage that coupling means can be milled efficiently on the side edges of the panel in the carrier plate. These coupling means will enable the mechanical coupling of the panels for the achievement of a floor covering or a wall covering.

Preferably, the carrier plate can be or comprise a mineral plate, for example a magnesium oxide plate or a cement fibre plate.

A preferred embodiment is characterized in that after compacting, or when the carbonatation is performed in at least two steps after a first carbonatation step and before a subsequent carbonatation step, the sheet form is cut into panels and/or coupling means are milled at least at two opposite edges of the sheet form and/or of the sawn panels. This allows to saw and/or mill the rigid material with easier and with less energy and with better quality compared to the more brittle panel after carbonatation. After carbonatation, the panel then gains its final strength.

A preferred embodiment is characterized in that the method comprises the step in which the surface of the panel obtained by carbonatation undergoes a mechanical processing—for example by means of polishing or sandblasting—for obtaining a visual surface effect (for example a gloss effect or an artificial aging), preferably wherein the mass which comprises the carbonatable powder also comprises colour pigments (preferably inorganic pigments) or other fillers (for example shells, granite powder or marble powder) for decorative application. This will provide a visually beautiful decorative panel.

A preferred embodiment is characterized in that the mass is compacted into a sheet form with a pressure of at least 500N/cm², preferably with a pressure of at least 1000N/cm², more preferably with a pressure of at least 1500N/cm². This embodiment ensures that panels with lower porosity are obtained after carbonatation. As a result better mechanical properties are obtained, including a higher bending strength. A higher bending strength is especially important with thin panels. Furthermore, a lower porosity is also beneficial for the water resistance of the panels.

The second aspect of the invention relates to a method for manufacturing a decorative panel, characterized in that the panel comprises a substrate obtained by carbonatation of a carbonatable powder; and a decorative top layer; wherein optionally the substrate is obtained using a method according to any one of the embodiments of the first aspect of the invention; wherein the method of the second aspect comprises the step in which a decorative top layer is applied to the substrate.

A preferred embodiment of the second aspect of the invention is characterized in that the decorative top layer is at least obtained by digital printing of the substrate; preferably followed by applying a coating, for example a UV-hardening, thermosetting or electron beam-curing acrylic coating or epoxy coating, and curing this coating. These embodiments allow to obtain a beautiful decorative surface.

This digital printing can be done with a UV hardening ink, with a water-based ink or with a solvent-based ink.

Preferably, the printing is formed in register with a texture in the substrate. This will provide a realistic imitation of natural materials, for example a wood imitation or an imitation of natural stone, e.g., marble.

A preferred embodiment of the second aspect of the invention is characterized in that the decorative top layer is at least obtained due to the fact that the substrate—or at least a top layer of the substrate—comprises colour pigments (preferably inorganic pigments) or other fillers (for example shells, granite powder or marble powder) for decorative application; wherein these colour pigments or other fillers form a visible decoration on a surface of the decorative panel.

Optionally, the method comprises the step of applying a coating, for example a UV-hardening, thermosetting or electron beam-curing acrylic coating or an epoxy coating, and curing of this coating.

Applying and curing a coating offer the advantage that the scratch resistance of the surface is improved. A coating will also ensure a better chemical resistance.

A preferred embodiment of the second aspect of the invention is characterized in that the decorative top layer is at least obtained by colouring the upper side of the substrate, preferably wherein the upper side comprises a texture, preferably followed by the application of a coating, for example a UV-hardening or thermosetting acrylic coating or an epoxy coating, and the curing of this coating. This allows to efficiently obtain a decorative pattern. If a colour is applied on a top layer with texture, colour shadings can also be obtained in register with the texture. This allows to produce realistic imitations of natural materials, for example wood or natural stone (e.g., marble).

Optionally, the method comprises the step in which the surface of the panel obtained by carbonatation undergoes a mechanical processing—for example by means of polishing or sandblasting—for obtaining a visual surface effect, for example a gloss effect or an artificial aging. This will provide a visually beautiful decorative panel.

A preferred embodiment of the second aspect of the invention is characterized in that the decorative top layer is at least obtained due to the fact that a layer of stone (for example stone veneer, or porcelain, or ceramic) is glued to the substrate. This will provide a visually beautiful decorative surface, while the use of the expensive product (the layer of stone) remains limited.

A preferred embodiment of the second aspect of the invention is characterized in that the decorative top layer is at least obtained by laminating a decor layer on the substrate, wherein the decor layer comprises a decorative print, preferably a decorative print on a sheet of paper.

The decor layer may be or comprise an HPL (High Pressure Laminate), which is glued to the substrate by means of glue.

The decor layer may be or comprise a printed sheet of paper impregnated with resin (for example melamine formaldehyde resin, or acrylic resin or polyester resin); wherein the decor layer is laminated to the substrate with an adhesive layer or with the resin of the decor layer. For example, the adhesive layer can be or comprise vinyl acetate, acrylic, vinyl/acrylate, polyurethane, with or without a crosslinker, e.g., carbodiimide.

Preferably, a wear layer can be applied after or at the same time as applying the decorative layer. Optionally, the wear layer comprises a resin-impregnated sheet of paper (preferably wherein the wear layer comprises wear-resistant particles, e.g. corundum) and is laminated with an adhesive layer (for example vinyl acetate, acrylic, vinyl/acrylate, polyurethane, with or without a crosslinker, e.g. carbodiimide) or with the resin of the decor layer on the decor layer. This will provide a decorative panel with particularly good wear resistance.

The third aspect of the invention is a panel, preferably a decorative panel, characterized in that the panel comprises at least a substrate that has been obtained by carbonatation and/or that comprises a limestone matrix, wherein the substrate has a thickness T less than 60 mm; preferably less than 30 mm, more preferably less than 20 mm, more preferably less than 14 mm; more preferably less than 10 mm; more preferably less than 8 mm; more preferably less than 5 mm; and preferably more than 3 mm. Optionally, the substrate is a panel which has been obtained by using a method according to any one of the embodiments of the first aspect of the invention; or the panel is a decorative panel according to any one of the embodiments of the second aspect of the invention.

These panels offer the advantage that they can be manufactured with a limited amount of energy, and that they have an extremely low CO₂ footprint. This is because CO₂ is bound into the panels during the manufacture of these panels.

A preferred embodiment of the third aspect of the invention is characterized in that the substrate comprises wood chips and/or wood fibres. This allows to obtain panels with the desired mechanical properties. This also allows to have a more efficient milling of coupling means on the side edges of these panels. Also, the presence of the wood chips and/or the wood fibres allows that a decor layer can be laminated to the surface of the panel using melamine or another resin in order to form a decorative panel. This will ensure a good adhesion of this decor layer.

A preferred embodiment of the third aspect of the invention is characterized in that the substrate comprises reinforcing fibres. This will provide panels with high strength and favourable mechanical properties.

Preferably, the reinforcing fibres are selected from one or more of:
wood fibres;
synthetic fibres, such as for example polyethylene fibres, polypropylene fibres, polyester fibres, polyvinyl alcohol fibres, polyamide fibres, acrylic fibres, aramid fibres;
cellulose fibres, such for example as cotton, flax, hemp, bamboo, jute, sisal, elephant grass, flax, coconut fibre or ramie;
animal fibres, such as for example wool or other animal hair;
inorganic fibres, such as for example glass fibres, basalt fibres, metal fibres, carbon fibres.

Preferably, the average length of the reinforcing fibres is between 3 and 40 mm, preferably between 3 and 20 mm. This provides good strength of the panel.

Preferably, the reinforcing fibres have an average aspect ratio between 75 and 1000, preferably between 75 and 400; wherein the aspect ratio is determined by the length divided by the apparent diameter. This will ensure a good strength of the panel.

A preferred embodiment of the third aspect of the invention is characterized in that the substrate comprises one or more non-woven fabrics, for example one or more non-woven fabrics made up of glass fibres, wherein said one or more non-woven fabrics are parallel to the panel. This increases the mechanical properties of the manufactured panel.

A preferred embodiment of the third aspect of the invention is characterized in that the surface of the panel comprises a decorative texture, for example a wood structure or a natural stone structure, e.g., a marble structure. This will ensure a more realistic imitation of natural materials.

A preferred embodiment of the third aspect of the invention is characterized in that the bottom of the panel comprises a relief. This allows to make lighter panels. This relief is also favourable for gluing the panels on a surface.

A preferred embodiment of the third aspect of the invention is characterized in that the substrate furthermore is bound by a polymer binder. This will provide better mechanical properties. The brittleness of the panel is therefore lower. This makes it easier to mill mechanical coupling means on the side edges of the panel; and the milled mechanical coupling means are of better quality.

This additional polymer binder is, for example, an acrylate, a styrene acrylate, a vinyl acetate, a vinyl acetate chloride, a styrene butadiene copolymer, or a vinylidene chloride.

A preferred embodiment of the third aspect of the invention is characterized in that the substrate comprises colour pigments (preferably inorganic pigments) or other fillers for decorative application, which are visible on a surface of the panel. This allows to obtain a decorative surface with material made up of the substrate itself, so that no additional production step is required to obtain a decorative surface.

These other fillers may, for example, be or comprise shells, granite powder or marble powder.

A preferred embodiment of the third aspect of the invention is characterized in that the substrate comprises different layers, wherein at least two layers of the substrate differ in the composition; preferably, the substrate comprises at least three different layers formed by means of carbonatation. This allows to provide layers with different properties, so that the panel as a whole has better properties. For example, a top layer can be coloured decoratively while the other layers are not. It is also possible to create some kind of a sandwich structure with different properties in the core layer in comparison with the two outer layers.

In a preferred embodiment, the substrate comprises a top layer and a second layer below the top layer, wherein the top layer is harder and/or more brittle than the second layer. For example, the more flexible second layer makes it easier to mill mechanical coupling means on the edges of the panel, while the top layer will provide the mechanical properties.

Optionally, the substrate under the second layer may comprise a third layer, wherein the third layer is harder and/or more brittle than the second layer. For example, the more flexible second layer makes it easier to mill mechanical coupling means on the edges of the panel, while the top layer and the third layer provide the mechanical properties.

A preferred embodiment of the third aspect of the invention is characterized in that the top layer of the substrate comprises colour pigments (preferably inorganic pigments) or other fillers (for example shells, granite powder or marble powder) for decorative application; and the second layer of the substrate does not comprise them. This allows to optimize the use of material while still obtaining a beautiful decorative surface.

A preferred embodiment of the third aspect of the invention is characterized in that the top layer of the substrate and/or the under layer of the substrate comprises a higher weight of reinforcing fibres per unit of volume than at least one other layer of the substrate. This allows the properties—including the mechanical properties—of the panel to be optimized.

A preferred embodiment of the third aspect of the invention is characterized in that the panel comprises a plate, wherein the plate comprises at least the substrate and a carrier plate. This offers the advantage that coupling means can be milled efficiently on the side edges of the panel in the carrier plate. These coupling means will enable the mechanical coupling of the panels for the achievement of a floor covering or a wall covering.

Preferably, the carrier plate can be or comprise a mineral plate, for example a magnesium oxide plate or a cement fibre plate.

A preferred embodiment of the third aspect of the invention is characterized in that the panel comprises a decorative top layer.

In a preferred embodiment, a decorative top layer is obtained at least by means of a decorative printing—preferably by digital printing of the substrate—; preferably wherein the decorative top layer comprises a coating, for example a UV-hardening or thermoset acrylic coating or an epoxy coating.

Digital printing can be performed in the context of the invention with a UV-curing ink, with a water-based ink or with a solvent-based ink.

Preferably, the decorative printing is formed in register with a texture in the surface of the panel, preferably with a texture in the surface of the substrate. This ensures that a realistic imitation of natural materials is obtained, for example a wood imitation or an imitation of a natural stone, e.g., of marble.

A preferred embodiment of the third aspect of the invention is characterized in that a decorative top layer is at least obtained due to the fact that the substrate—or at least a top layer of the substrate—comprises colour pigments (preferably inorganic pigments) or other fillers (for example shells, granite powder or marble powder) for decorative application; wherein these colour pigments or other fillers form a visible decoration on a surface of the decorative panel.

Optionally, this decorative top layer can comprise a coating, for example a UV-hardening or thermoset acrylic coating, or an epoxy coating.

A preferred embodiment of the third aspect of the invention is characterized in that a decorative top layer is at least obtained by colouring the upper side of the substrate, preferably wherein the upper side comprises a texture.

Preferably, the colouring shows a colour shading according to a texture provided. This allows to obtain a very realistic imitation of natural materials.

Preferably, such a decorative top layer comprises a coating, for example a UV-hardening or thermoset acrylic coating, or an epoxy coating.

A preferred embodiment of the third aspect of the invention is characterized in that the decorative top layer comprises a layer of stone (for example stone veneer, or porcelain, or ceramic), preferably glued to the substrate. This will provide a visually beautiful decorative surface, wherein the use of the expensive product (the layer of stone) remains limited.

A preferred embodiment of the third aspect of the invention is characterized in that the decorative top layer comprises a decor layer laminated on the substrate, wherein the decor layer comprises a decorative print, preferably a decorative print on a sheet of paper.

The decor layer may be or comprise an HPL (High Pressure Laminate), which is glued to the substrate by means of glue.

A preferred embodiment of the third aspect of the invention is characterized in that the decor layer is or comprises a resin-impregnated printed sheet of paper; wherein the decor layer is laminated to the substrate with an adhesive layer or with the resin of the decor layer.

For example, the resin may be a melamine formaldehyde resin, or an acrylic resin, or a polyester resin.

For example, the adhesive layer can be or comprise vinyl acetate, acrylic, vinyl/acrylate, polyurethane, with or without a crosslinker, e.g., carbodiimide.

Preferably, the decorative top layer comprises a wear layer. The wear layer optionally comprises a resin-impregnated sheet of paper. Preferably, the wear layer comprises wear-resistant particles, for example corundum. This kind of wear layers will ensure a high wear resistance of the panel.

A preferred embodiment of the third aspect of the invention is characterized in that the panel is rectangular, whether square or elongated, wherein the panel is provided with coupling means at least at two opposite edges, which allow to couple two panels of this kind to each other at the respective edges, wherein a locking in the coupled state exists in the vertical direction perpendicular to the plane of the coupled panels and in the horizontal direction perpendicular to the coupled edges and in the plane of the coupled panels; wherein the aforementioned coupling means include at least a male part in the form of a tongue, wherein the aforementioned coupling means comprise at least a female part in the form of a groove, preferably wherein this groove is flanked by a lower lip and an upper lip.

This kind of embodiments allows to install the panels easily in a floor covering.

Preferably this panel is a decorative panel.

Preferably, the mechanical coupling means are mainly designed as a tongue and a groove delimited by an upper lip and a lower lip, wherein these tongue and groove are primarily responsible for the locking in the aforementioned vertical direction, and wherein the tongue and groove comprise locking parts, wherein these locking parts are mainly responsible for the locking in the aforementioned horizontal direction; preferably, the locking parts include a protrusion at the lower lip of the groove and a cooperating recess at the bottom of the tongue.

Preferably, the aforementioned coupling means can be applied in each other by means of a turning movement.

In a preferred embodiment, the coupling means are designed so that an imitation of a joint is formed on the coupled edges of the panel on a second panel of this kind. This ensures that a more realistic imitation of a covering by means of tiles can be obtained.

Optionally, the imitation of the joint can be obtained by applying a grout and/or by a coating on at least one part of the coupling means.

Preferably, at least part of the at least two opposite edges comprise a water-repellent coating. This increases the moisture resistance of coverings formed with panels of this kind.

In a preferred embodiment, wherein the substrate comprises a top layer and comprises a second layer under the top layer, wherein the top layer is harder and/or more brittle than the second layer; the coupling means are mainly realized in the second layer. The more flexible second layer makes it easier to mill mechanical coupling means on the edges of the panel, while the top layer will provide the mechanical properties. There is also less risk of breakage of the coupling means during transport and installation of the panels; and in coverings formed with these panels.

Optionally, the substrate under the second layer comprises a third layer, wherein the third layer is harder and/or more brittle than the second layer. The more flexible second layer makes it easier to mill mechanical coupling means on the edges of the panel, while the top layer and the third layer provide the mechanical properties. There is also less risk of breakage of the coupling means during transport and installation of the panels; and in coverings formed with these panels.

In a preferred embodiment, the panel comprises a plate, wherein the plate comprises at least the substrate and a carrier plate, wherein the coupling means are mainly—and preferably completely—realized in the carrier plate. The coupling means can therefore be made up of material that is better suited in terms of mechanical properties for the manufacture—for example by means of milling—of the coupling means; and for the durability of the coupling means during transport and installation of the panels and when using a coating which comprises panels of this kind.

Preferably, the carrier plate can be or comprise a mineral plate, for example a magnesium oxide plate or a cement fibre plate.

The fourth aspect of the invention relates to a panel according to any one of the embodiments of the third aspect of the invention, characterized in that the panel is a floor panel; and preferably has a thickness less than 20 mm; and more preferably has a thickness between 8 and 14 mm.

The fifth aspect of the invention relates to a floor covering, characterized in that the floor covering comprises a number of panels according to any one of the embodiments of the fourth aspect of the invention.

The sixth aspect of the invention relates to a panel according to any one of the embodiments of the third aspect of the invention, characterized in that the panel is a wall panel; and preferably has a thickness less than 5 mm.

The seventh aspect of the invention relates to a wall covering, characterized in that the wall covering comprises a number of panels according to any one of the embodiments of the sixth aspect of the invention.

In the embodiments of the various aspects of the invention wherein the substrate is digitally printed, preferably one or a combination of two or more of the following characteristics may be employed:
prior to the digital printing, the substrate surface on which digital printing will be done is sanded or sandblasted;
prior to the digital printing, a water-based silane is applied to the surface of the substrate on which digital printing will be done. More preferably, this water-based silane acts as a primer and/or coupling agent for the digital printing;
the application of an acrylic primer, preferably a UV-curing acrylic primer. Preferably, between 5 and 20 grams of dry matter per square metre of acrylic primer is applied. Preferably, an applied UV-cured acrylic primer is gelled, preferably by means of an Hg lamp, a Ga lamp or a LED;
the application prior to the digital printing of one or more white base layers, preferably white acrylic base layers, more preferably white UV-curable acrylic base layers;
the application after the digital printing of a wear layer—for example by means of a UV-curable acrylic. More preferably, the wear layer contains UV absorbers, preferably UV-A absorbers and/or Hindered-Amine Light Stabilisers;
the application of a texture to the digitally printed surface by means of digital texturing.

With the insight to better demonstrate the characteristics of the invention, a few preferred embodiments are described here below, without any limiting character, with reference to the accompanying drawings, in which:

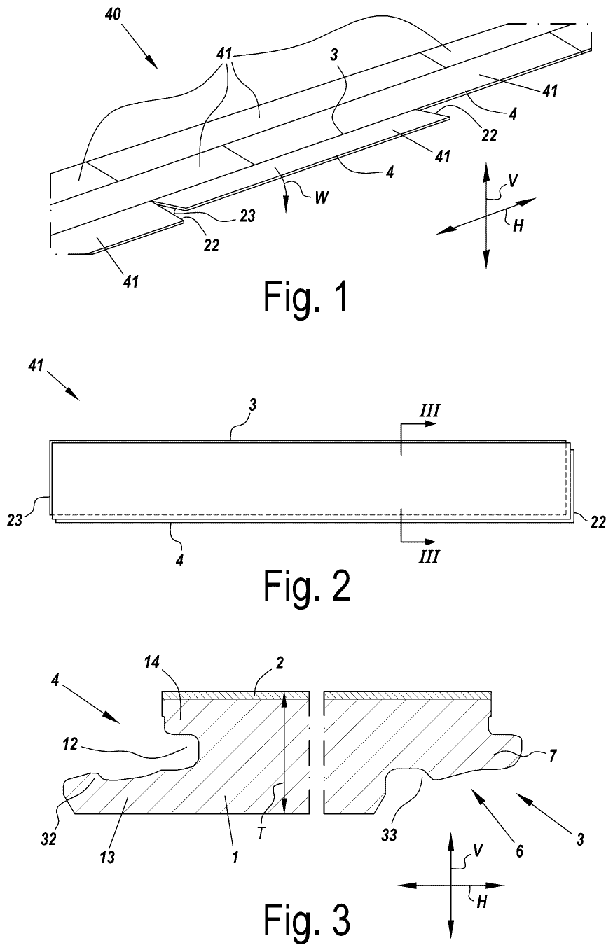

FIG. 1 shows a floor covering which comprises decorative panels according to the invention;

FIG. 2 represents a panel-according to the invention-as used in the floor covering of FIG. 1;

FIG. 3 represents a cross-section according to III-III of the panel of FIG. 2;

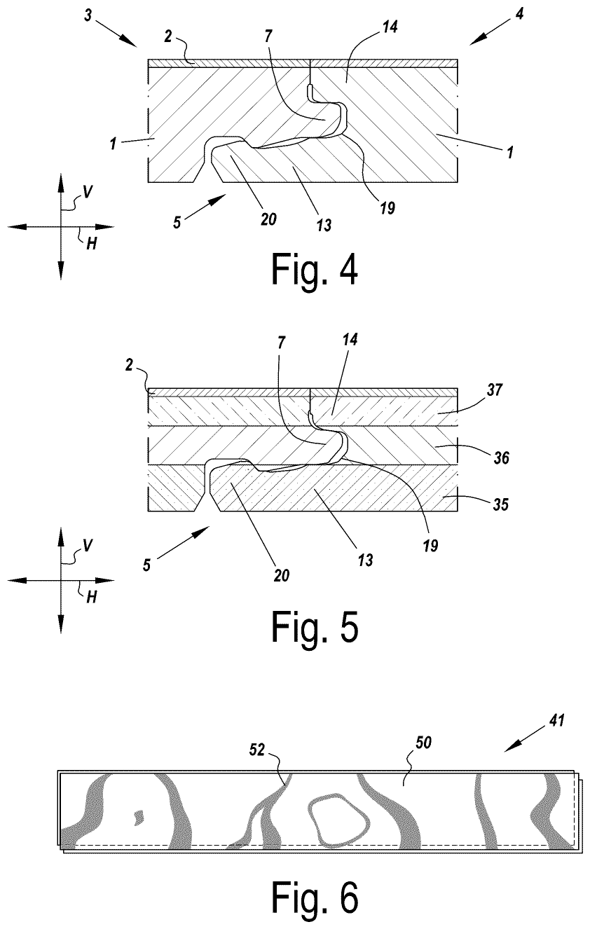

FIG. 4 shows two panels as shown in FIGS. 2 and 3 in the coupled state at their long edges;

FIG. 5 shows an example of panels according to the invention, in the coupled state, wherein the panels comprise a substrate which comprises three different layers formed by means of carbonatation; and

FIG. 6 shows the surface of an embodiment of a decorative panel according to the invention.

FIG. 1 represents a floor covering 40 formed by decorative panels 41 according to the invention. The decorative panels 41 are coupled to each other at their first pair of opposite edges 3, 4 by means of their respective coupling means; and are also coupled to each other at their second pair of opposite edges 22, 23. Wall coverings can also be realized in the same way according to the invention.

FIG. 2 shows a panel 41 as used in the floor covering of FIG. 1. The panel is elongated and rectangular and comprises a first pair of opposite edges 3, 4 with coupling means at its long edges. The short pair of opposite edges 22, 23 also has coupling means. The coupling means 22, 23 on the short pair of opposite edges can be realized in an analogous way to the coupling means at the long edges. However, this is not necessarily the case for the invention.

FIGS. 3 and 4 show an example of a panel according to FIG. 2. FIG. 3 shows a cross section according to III-III of the panel of FIG. 2. FIG. 4 shows two panels according to FIG. 2 coupled at their long edges 3, 4, hence at the illustrated edges in FIG. 3.

The panel of FIGS. 2-4 comprises a substrate 1 and a decorative top layer 2 applied to it. The substrate is obtained by carbonatation and therefore comprises a limestone matrix. The panel has a thickness T. The substrate may comprise reinforcing fibres.

The panel is at its two long opposite edges 3, 4 provided with coupling means 5 that allow to couple two panels of this kind to each other at the respective edges, wherein in the coupled state a locking exists in the vertical direction V perpendicular in relation to the plane of the coupled panels and in the horizontal direction H perpendicular in relation to the coupled edges and in the plane of the coupled panels. This coupling can be done by means of a turning movement W, as it is shown in FIG. 1.

The coupling means 5 of the one edge 3 of the two long opposite edges 3, 4 include a male part 6 in the form of a tongue 7; and on the other edge 4 a female part in the form of a groove 12. This groove is flanked by a lower lip 13 and a top lip 14, wherein the lower lip comprises a locking element 32 and wherein the bottom side of the tongue 7 comprises a recess 33, so that, in the coupled condition of two panels of this kind, the contact between the locking element 32 and the recess 33 ensures the locking of the coupled panels in the direction perpendicular to the edges thus coupled and parallel to the plane of the coupled panels.

FIG. 5 shows an example of panels according to the invention, in the coupled state, wherein the panels comprise a substrate which comprises three different layers—a first layer 35, a second layer 36 and a third layer 37—formed by means of carbonatation. The carbonatation of these different layers was performed in the same carbonatation step, so that there is an excellent adhesion between these layers. With regard to the configuration of the coupling means, these panels are in terms of configuration of the coupling means similar to those of FIGS. 3 and 4. The reference numbers in FIG. 5 have therefore the same meaning as the corresponding reference numbers in FIGS. 3 and 4.

The panels in FIG. 5 comprise a substrate which comprises three different layers—a first layer 35, a second layer 36 and a third layer 37—formed by means of carbonatation. The second layer 36 is situated between the first layer 35 and the third layer 37, wherein the third layer 37 of these three layers is closest to the surface of the panel. At least two of these three layers have a different composition. Preferably, at least the second layer 36 has a different composition than the first layer 35, and preferably also than the third layer 37. The tongue 7 is mainly made in the second layer 36. The bottom lip 13 is mainly made in the first layer 35. The top lip 14 is mainly made in the third layer 37.

It is advantageous if the first layer 35 has a higher specific elastic bending ability than the second layer 36. For example, the first layer 35 may comprise more reinforcing fibres per unit of mass than the second layer 36. The third layer 37 may comprise more reinforcing fibres per unit of mass than the second layer 36.

FIG. 6 shows the surface of an embodiment of a decorative panel 41 according to the invention. In this embodiment, two masses which comprise a carbonatable powder were brought together into a sheet form. These two masses which comprise a carbonatable powder differ in colour. This will provide a decorative colour pattern on the surface of the sheet form because both masses which comprise a carbonatable powder each form a part of the surface of the decorative panel. In the example, a black vein 52 (due to the fact that this part of the surface is formed by a mass which comprises a carbonatable powder which also comprises black pigments) is formed against a lighter background 50 (due to the fact that this part of the surface is formed by a mass which comprises carbonating powder with light colour) as an imitation of marble.

For example, a mass which comprises a carbonatable powder for use in the invention may be composed as follows:
70 to 97 parts by weight (and preferably 90 parts by weight) of a carbonatable powder which comprises between 15 and 35% by weight (and preferably 35% by weight) Ca²⁺;
1 to 20 parts by weight (and preferably 10 parts by weight) of a fast-setting cement;
5 to 25 parts by weight (and preferably 15 parts by weight) of water;
0.1 to 5 parts by weight (and preferably 1 part by weight) of polyvinyl alcohol (PVA) fibres;
0.1 to 10 parts by weight (and preferably 5 parts by weight) of a pigment, for example carbon black;
0.01 to 1 part by weight (and preferably 0.02 part by weight) of a superplasticizer;

Optionally, 0.1 to 8 parts by weight (preferably 5 parts by weight) of a wear-resistant particle, for example aluminum oxide, may be further added.

This dry powder mass was compacted for 10 minutes at a temperature of 60 °C with a pressure of 1300 N/cm² in a press along with a textured press plate of a stone imitation. After this compaction, the stone imitation texture of the plate was taken over in the compacted mass, which is now a mass-coloured tile with a thickness of 8 mm. The texture varies locally from 20 μm to 3000 μm.

This was followed by the carbonatation step in a chamber enriched with CO₂, under a pressure of at least 2 bar, for a period of time of at least 10 hours.

After the tile has finally hardened, a first transparent primer layer is applied through the application of 5 to 20 grams per square meter of a UV-hardening acrylic. This transparent primer layer is gelled by means of a UV radiation.

This will be followed by the application of a second transparent wear layer through the application of 50-200 grams per square meter of a UV-hardening acrylic. Optionally, this UV-hardening acrylic may comprise wear-resistant particles, for example aluminum oxide (for example 5-20 weight percent aluminum oxide particles with an average particle size of between 50 and 90 μm). This layer is gelled using UV radiation.

Afterwards, a final topcoat is applied in the form of 5 to 20 grams per square meter of a UV-hardening acrylic that optionally comprises scratch-resistant particles such as aluminum oxide (for example 2 to 10% by weight of aluminum oxide particles with a particle size of 3 to 15 μm). Afterwards, the combined coating layers are cured by means of a UV radiation or by means of an electron beam radiation. In this way, a decorative, wear-resistant panel is obtained that can be used as a floor tile.

The present invention is by no means limited to the embodiments which were described hereabove, but different variants can be realized without going beyond the scope of the present invention.

1.-93. (canceled)

94. A decorative panel, wherein the panel comprises at least a substrate which is obtained by carbonatation or comprises a limestone matrix,
wherein the substrate has a thickness T less than 60 mm.

95. The decorative panel according to claim 94, wherein the substrate comprises wood chips or wood fibres.

96. The decorative panel according to claim 94, wherein the bottom of the panel comprises a relief.

97. The decorative panel of claim 94, wherein the substrate in addition is bound by a polymer binder.

98. The decorative panel of claim 94, wherein the decorative panel comprises a decorative top layer,
wherein the decorative top layer is at least obtained by a decorative printing of the substrate.

99. The decorative panel of claim 94, wherein the decorative printing is formed in register with a texture in the surface of the decorative panel.

100. The decorative panel of claim 94, wherein the decorative panel comprises a decorative top layer,
wherein the decorative top layer is at least obtained in that the substrate comprises colour pigments or other fillers for decorative application;
wherein these colour pigments or other fillers form a visible decoration on a surface of the decorative panel.

101. The decorative panel of claim 94, wherein the decorative panel comprises a decorative top layer,
wherein the decorative top layer is at least obtained by colouring the top of the substrate.

102. The decorative panel of claim 94, wherein the decorative panel comprises a decorative top layer,
wherein the decorative top layer comprises a layer of stone veneer, or a layer of porcelain, or a layer of ceramic, glued to the substrate.

103. The decorative panel of claim 94, wherein the decorative panel comprises a decorative top layer,
wherein the decorative top layer comprises a decor layer laminated on the substrate,
wherein the decor layer comprises a decorative print.

104. The decorative panel of claim 103, wherein the decor layer is or comprises a HPL (High Pressure Laminate), which is glued to the substrate by an adhesive.

105. The decorative panel of claim 103, wherein the decor layer is or comprises a printed sheet of paper impregnated with resin;
wherein the decor layer is laminated with an adhesive layer or with the resin of the decor layer on the substrate.

106. The decorative panel of claim 104, wherein the decorative layer comprises a wear layer.

107. The decorative panel of claim 94, wherein the panel is rectangular, whether square or elongated,
wherein the panel is provided with coupling parts at least at two opposite edges, which allow to couple two panels of this kind to each other at the respective edges,
wherein a locking in the coupled state exists in the vertical direction perpendicular to the plane of the coupled panels and in the horizontal direction perpendicular to the coupled edges and in the plane of the coupled panels;
wherein the aforementioned coupling parts include at least a male part in the form of a tongue;
wherein the aforementioned coupling parts include at least one female part in the form of a groove, wherein this groove is flanked by a lower lip and an upper lip.

108. The decorative panel of claim 107, wherein the mechanical coupling parts are mainly designed as a tongue and a groove delimited by an upper lip and a lower lip,
wherein these tongue and groove are primarily responsible for the locking in the aforementioned vertical direction, and
wherein the tongue and groove comprise locking parts,
wherein these locking parts are mainly responsible for the locking in the aforementioned horizontal direction.

109. The decorative panel of claim 107, wherein the coupling parts are designed so that the imitation of a joint is formed at the coupled edges of the panel on a second panel of this kind.

110. The decorative panel of claim 107, wherein at least a part of the at least two opposite edges comprises a water-repellent coating.

111. The decorative panel of claim 110, wherein the decorative panel comprises a plate;
wherein the plate comprises at least the substrate and a carrier plate;
wherein the coupling parts are mainly realized in the carrier plate.
